(19) United States
(12) Patent Application Publication
(10) Pub. No.: US 2009/0213737 A1
(43) Pub. Date: Aug. 27, 2009

(54) TEST SYSTEM WITH RETURN SWEEP LEVEL SETTING

(75) Inventor: Gregory R. Potter, Sugar Hill, GA (US)

Correspondence Address: LAW OFFICES OF MIKIO ISHIMARU, 333 W. EL CAMINO REAL, SUITE 330, SUNNYVALE, CA, 94087, US

(73) Assignee: SUNRISE TELECOM INCORPORATED, San Jose, CA (US)

(21) Appl. No.: 12/034,806

(22) Filed: Feb. 21, 2008

(51) Int. Cl. G06F 11/273

(52) U.S. Cl. 370/241

(57) ABSTRACT

A test system comprising: providing a conditioning circuit; cabling a cable modem termination system to the conditioning circuit; signaling an initial ranging request to the cable modem termination system; and determining a transmission power limiter by the conditioning circuit monitoring a network for detecting a cable modem termination system response to the initial ranging request.

### TECHNICAL FIELD

The present invention relates generally to communication testers, and more particularly to a system for testing a Data Over Cable Service Interface Specification (DOCSIS) network.

### BACKGROUND ART

Today people demand connectivity to services from all over the world without leaving their homes. They want video on demand, Internet access, live on-line gaming, and access to the world market place from the comfort of their living room. In order to support these ideas and requests a cable industry group developed the Data Over Cable Service Interface Specification (DOCSIS). DOCSIS defines a procedure for transferring digital information through the existing cable television infrastructure.

DOCSIS specifies downstream traffic transfer rates between 27 and 36 mega bits per second (Mbps) over a radio frequency (RF) path in the 50 mega hertz (MHz) to 750+ MHz range, and upstream traffic transfer rates between 320 kilo bits per second (Kbps) and 10 Mbps over a RF path between 5 and 42 MHz. But, because data over cable travels on a shared loop, individuals will see transfer rates drop as more users gain access. New proposals for the DOCSIS 3.0 specification may support transfer rates up to 160 Mbps in the downstream direction and 120 Mbps in the upstream direction in order to extend the useful life of the cable television (CATV) infrastructure.

In order to facilitate these transfer rates, the condition of the cable structure and its proper termination is critical. Many signal processing techniques, Time Division Multiple Access (TDMA), Quadrature Amplitude Modulation (QAM), Quadrature Phase Shift Keying (QPSK), Trellis Coded Modulation (TCM) and the like are used to extend the capabilities of the aging CATV structure.

A critical aspect of the DOCSIS operation requires maintaining the integrity of the cable structure itself. In order to maintain the operational integrity of the cable structure, sophisticated test and analysis equipment must be used to detect and resolve problems. By coupling specific test equipment to the cable test points, signals between the Cable Modem Termination System (CMTS) and the Cable Modem (CM) may be analyzed.

The downstream path, from the CMTS to the CM, is straightforward to analyze because the CMTS manages the transmission of signals into the cable structure. Power and phase of the transmission signals have already been adjusted to compensate for losses prior to the CMTS. In the structure beyond the CMTS there may be many branches or CM attach points that can affect the signal quality. Each node in the cable structure may require different signal processing and amplification in order to deliver good data to the end user. The analysis of the delivery path just accepts the transmitted data and examines the delivered signal for abnormalities in amplitude, phase, or modulation.

In order to analyze the upstream path, from the CM to the CMTS known as a return path, the test equipment must take over the transmission responsibilities by sourcing a signal that provides correct amplitude, frequency, phase, and modulation. The frequency, phase, and modulation may be defined by the specific channel that is under analysis. The amplitude of the signal injected into the upstream path has historically been determined by a best guess, trial and error process. If too much power is injected into the cable structure, distortion may impact all of the signals on the return path.

The process of setting the power limits for diagnostic transmission on the upstream path has historically been a manual process requiring caution not to impair the active signaling on the same cable structure. This process may be tedious and time consuming. It may also cause an undue amount of time to be spent by a highly trained technician adding cost to the maintenance process.

Thus, a need still remains for a return sweep level setting system for simplifying the analysis of the upstream path in the cable structure. In view of the overwhelming popularity high-speed content delivered to the home, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to save costs, improve efficiencies and performance, and meet competitive pressures, adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a test system including: providing a conditioning circuit; cabling a cable modem termination system to the conditioning circuit; signaling an initial ranging request to the cable modem termination system; and determining a transmission power limiter by the conditioning circuit monitoring a network for detecting a cable modem termination system response to the initial ranging request.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is a plan view of a test system with return sweep level setting, in an embodiment of the present invention;

FIG. 2 is a functional block diagram of a network having the test system with return sweep level setting, in an embodiment of the present invention;

FIG. 3 is an image of a return sweep display on the display screen of FIG. 1;

FIG. 4 is a communication block diagram of the test system with return sweep level setting, of FIG. 1; and

FIG. 5 is a flow chart of a test system with return sweep level setting for utilizing the test system with return sweep level setting in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. Where multiple embodiments are disclosed and described, having some features in common, for clarity and ease of illustration, description, and comprehension thereof, similar and like features one to another will ordinarily be described with like reference numerals.

For expository purposes, the term “horizontal” as used herein is defined as a plane parallel to the plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used.

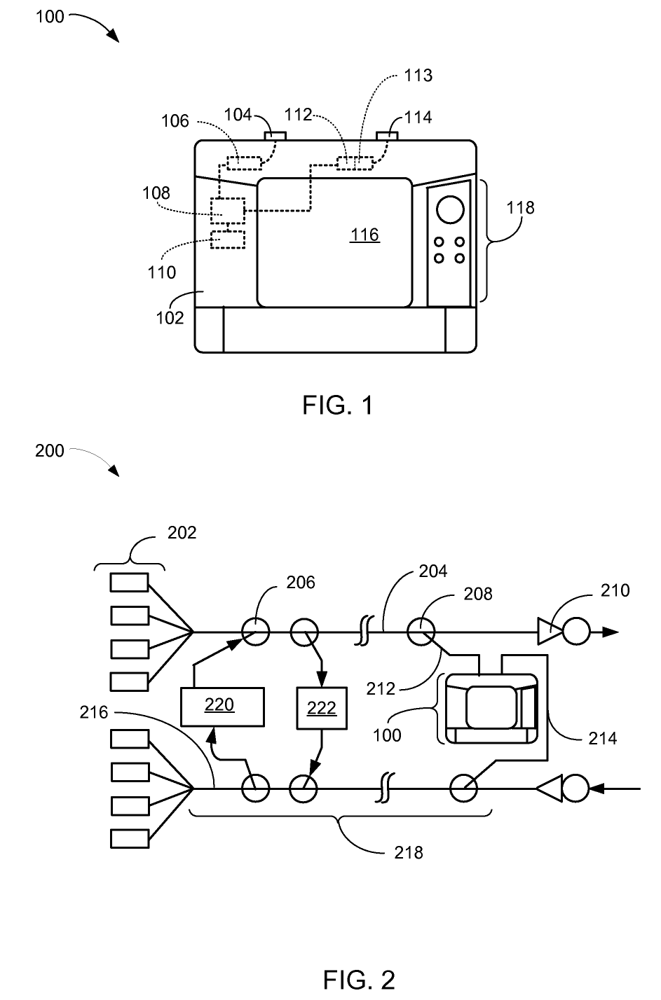

Referring now to FIG. 1, therein is shown a plan view of a test system with return sweep level setting 100, in an embodiment of the present invention. The plan view of the test system with return sweep level setting 100 depicts a controller unit 102, such as a tester controller unit, having a radio frequency (RF) input jack 104 mounted thereon. The RF input jack 104 is coupled to an RF receiver 106, which may be controlled by a conditioning circuit 108, such as a field programmable integrated circuit, an application specific integrated circuit or a micro processor. A non-volatile storage device 110, such as a memory or disk storage device, may be coupled to the conditioning circuit 108 for storing diagnostic data, set-up parameters, default parameters, or a combination thereof.

The conditioning circuit 108 may also be coupled to an RF transmitter 112, having a transmission power limiter 113, which is coupled to an RF output jack 114. A control panel 118 may be used to activate the functions of the test system with return sweep level setting 100. A display screen 116 may be used to present the diagnostic data, set-up information, or status. The test system with return sweep level setting 100 may be used to analyze a data over cable service interface specification (DOCSIS) network. It may be used to maintain the DOCSIS network by detecting problem interconnects. Problems such as damaged cables, high ingress levels, loose connectors, or corroded contacts may severely restrict the communication bandwidth of the network.

Referring now to FIG. 2, therein is shown a functional block diagram of a network 200 having the test system with return sweep level setting 100, in an embodiment of the present invention. The functional block diagram of the network 200 depicts a cable modem termination system (CMTS) 202 couples to a downstream cable 204. The downstream cable 204 may have a test coupling 206 or a number of a cable modem (CM) attach point 208 distributed along its length. A downstream buffer 210 may be used to boost signal levels or convert the signals to an optical protocol for longer distance distribution.

The test system with return sweep level setting 100 may be coupled to the test coupling 206 or the cable modem (CM) attach point 208 in the network 200. A radio frequency (RF) input cable 212 may be used to couple the test system with return sweep level setting 100 to the downstream cable 204. An RF output cable 214 may couple the test system with return sweep level setting 100 to an upstream cable 216 through the test coupling 206 or the cable modem (CM) attach point 208. The test couplings 206 and the cable modem attach points 208 are distributed on the downstream cable 204 and the upstream cable 216 at equivalent locations. That is to say, the distance from the cable modem termination system 202 to each of the test coupling 206 or the cable modem (CM) attach point 208 is the same on the downstream cable 204 and the upstream cable 216. Any difference in the transmission characteristics may be the result of damaged cables, loose connectors, corrosion, failed components, or a combination thereof.

The analysis of these problems must occur during the normal operation of the network 200. Downstream frequency sweeps may collect information about noise sources in the path from the cable modem termination system 202 to the cable modem attach point 208. This is the primary data payload delivery path. Just as important to peak performance of the network 200 is a return path 218, such as the upstream cable 216 between the cable modem attach point 208 and the cable modem termination system 202 including any of the test coupling 206 or the cable modem (CM) attach point 208. The return path 218 typically handles smaller payloads, such as requests for data, maintenance requests, or initialization exchanges.

A head end tester 220 may be coupled between the downstream cable 204 and the upstream cable 216. The head end tester 220 may receive a return sweep, such as a frequency sweep, from the test system with return sweep level setting 100 across the return path 218. The head end tester 220 may assemble the return sweep results in a graphical representation for sending the results on the downstream cable 204. An interface device 222, such as a cable modem or a cable branch amplifier, may be attached to the downstream cable 204 and the upstream cable 216 at the cable modem attach point 208.

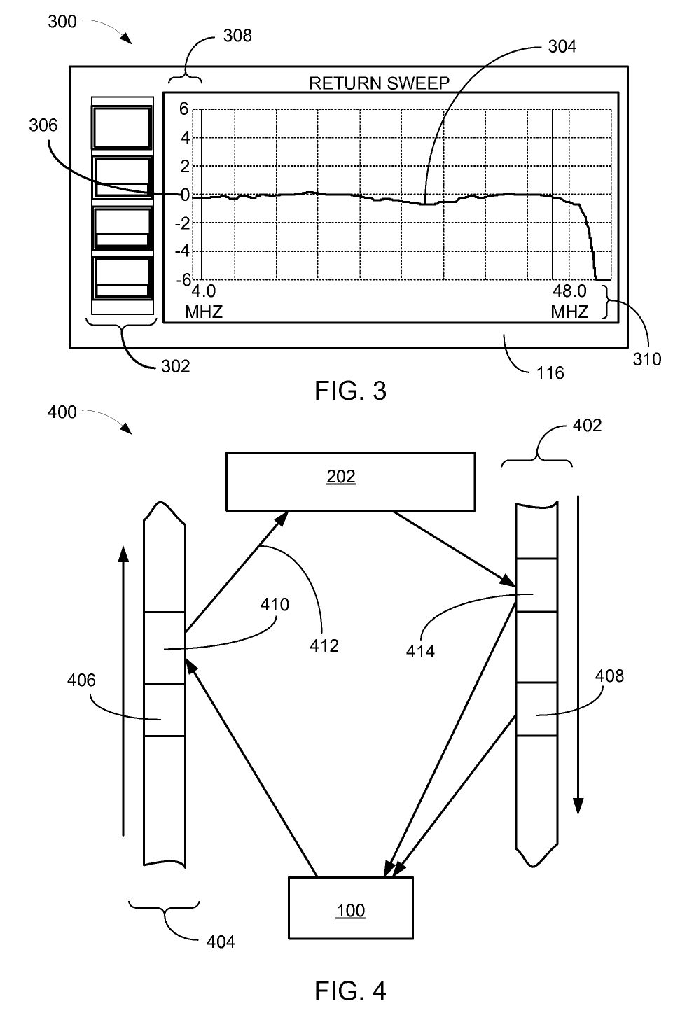

Referring now to FIG. 3, therein is shown an image of a return sweep display 300 on the display screen 116 of FIG. 1. The image of the return sweep display 300 depicts soft keys 302 aligned on the display screen 116. The soft keys 302, such as touch screen input keys, may provide a parameter input mechanism for the test system with return sweep level setting 100, of FIG. 1. A return sweep 304, such as a graphical display of amplitude versus frequency, may have a vertical scale 308 representing the relative amplitude of the return sweep 304 and a horizontal scale 310 representing the frequency span for the return sweep 304.

An ideal response to the return sweep 304 may be a straight line positioned on a zero marker 306 in the vertical scale 308. The vertical scale 308 may reflect a number of decibel milli-volts either added to or subtracted from the original signal level. The return sweep 304 samples a number of frequencies as represented by the horizontal scale 310 representing the frequencies in megahertz. The frequency limits of the return sweep 304 may vary. The frequency limits displayed represent the frequencies defined for the return path 218, of FIG. 2, by the Data Over Cable Service Interface Specification (DOCSIS) version 1.0. Other versions of the specification may define new ranges of frequencies for the return path 218. The return sweep 304 may display a problem in the return path 218, such as damage to the upstream cable 216, a loose coupling or corrosion on the cable modem attach point 208, the test coupling 206, the upstream cable 216, or a combination thereof.

Historically the set-up for the analysis of the return path 218 required a manual power adjustment so that the testing device could send a proper level signal into the upstream cable 216 of FIG. 2. If the transmission power limiter 113, of FIG. 1, coupled to the upstream cable 216 was too low, it might not be properly detected by the head end tester 220, of FIG. 2. If the transmission power limiter 113 into the upstream cable 216 was too high, it might disrupt the transmission of other devices coupled to the upstream cable 216. This critical adjustment of the transmission power limiter 113 used for the return sweep 304 could be very time consuming and might disrupt the communication on the upstream cable 216 several times before an accurate representation of the return sweep 304 could be captured.

It has been discovered that information exchanged between the test system with return sweep level setting 100 and the cable modem termination system 202 of FIG. 2 during the initialization process may contain sufficient information to automatically adjust the transmission power limiter 113 in preparation for capturing the return sweep 304 without manual intervention. This discovery minimizes the amount of time and disruption of communication on the return path 218 required to capture an accurate representation of the return sweep 304.

Referring now to FIG. 4, therein is shown a communication block diagram of a head end initialization process 400 with the test system with return sweep level setting 100, of FIG. 1. The communication block diagram of the head end initialization process 400 depicts the cable modem termination system 202 having a downstream communication flow 402 and an upstream communication flow 404. The test system with return sweep level setting 100 may receive information from the downstream communication flow 402 and transmit information into the upstream communication flow 404. The downstream communication flow 402 and the upstream communication flow 404 typically operate in a burst mode of transmission. Time in the upstream communication flow 404 is slotted with a defined allocation for each slot.

The cable modem termination system 202 allocates time slots 406 and controls the usage for each of the time slots 406 in the upstream communication flow 404. The cable modem termination system 202 sends a map message 408 at regular intervals in the downstream communication flow 402. The cable modem termination system 202 may allocate the time slot 406, such as a contention broadcast slot, that all of the interface devices 222, of FIG. 2, can use or it may allocate a dedicated slot 410 for the use of a specific unit of the interface device 222.

In the example of FIG. 4, the cable modem termination system 202 may be communicating with the test system with return sweep level setting 100. After being reset, the test system with return sweep level setting 100 may monitor the downstream communication flow 402 in order to detect the map message 408. The test system with return sweep level setting 100 may utilize the time slot 406 or the dedicated slot 410 in order to transmit an initial ranging request 412 to the cable modem termination system 202. In response to the initial ranging request 412, a cable modem termination system response 414, such as a polling sequence, may be initiated with all of the interface devices 222 that may be connected to the network 200, of FIG. 2. In this example the test system with return sweep level setting 100 would respond as though it were one of the interface devices 222.

The cable modem termination system 202 may complete the ranging process with all of the devices attached to the network 200. The test system with return sweep level setting 100 may determine a power level used by the cable modem termination system 202. The test system with return sweep level setting 100 may then use the power settings determined from the cable modem termination system 202 to set its own copy of the transmission power limiter 113, of FIG. 1, in preparation for generating the return sweep 304, of FIG. 3.

It has been unexpectedly discovered that the test system with return sweep level setting 100 may properly adjust its transmission power regardless of its position on the network 200 without intervention by an operator. This capability has reduced the set-up overhead and contention associated with executing the return sweep 304 in an active network 200.

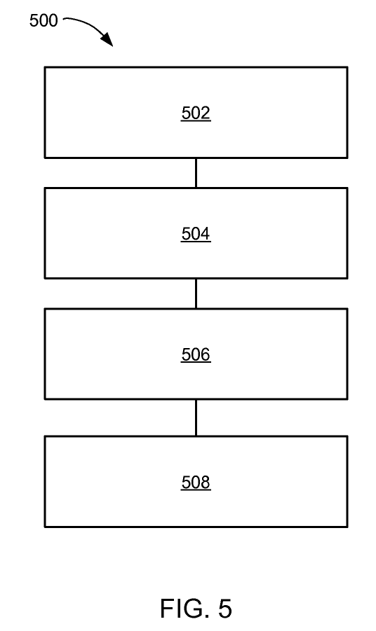

Referring now to FIG. 5, therein is shown a flow chart of a test system with return sweep level setting 500 for utilizing the test system with return sweep level setting 100 in an embodiment of the present invention. The system 500 includes providing a conditioning circuit in a block 502; cabling a cable modem termination system to the conditioning circuit in a block 504; signaling an initial ranging request to the cable modem termination system in a block 506; and determining a transmission power limiter by the conditioning circuit monitoring a network for detecting a cable modem termination system response to the initial ranging request in a block 508.

It has been discovered that the present invention thus has numerous aspects.

A principle aspect that has been unexpectedly discovered is that the present invention may automatically set the transmission power level in preparation for generating the return sweep on the return path.

Another aspect is that the present invention may be attached to any point on the network without having prior special knowledge of the network topology in order to generate the return sweep.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the return sweep level setting system of the present invention furnishes important and heretofore unknown and unavailable solutions, capabilities, and functional aspects for network analyzers. The resulting processes and configurations are straightforward, cost-effective, uncomplicated, highly versatile and effective, can be surprisingly and unobviously implemented by adapting known technologies, and are thus readily suited for efficiently and economically manufacturing network analyzer devices fully compatible with conventional manufacturing processes and technologies. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A test system comprising:
providing a conditioning circuit;
cabling a cable modem termination system to the conditioning circuit;
signaling an initial ranging request to the cable modem termination system; and
determining a transmission power limiter by the conditioning circuit monitoring a network for detecting a cable modem termination system response to the initial ranging request.

2. The system as claimed in claim 1 wherein cabling the cable modem termination system includes coupling a downstream cable and an upstream cable to the cable modem termination system.

3. The system as claimed in claim 1 further comprising analyzing a return path by using the transmission power limiter.

4. The system as claimed in claim 1 wherein providing the conditioning circuit includes:
controlling a radio frequency receiver by the conditioning circuit;
controlling a radio frequency transmitter by the conditioning circuit; and
controlling the transmission power limiter by the conditioning circuit.

5. The system as claimed in claim 1 wherein monitoring the network includes:
attaching a downstream cable to the conditioning circuit;
attaching an upstream cable to the conditioning circuit;
providing a head end tester coupled between the downstream cable and the upstream cable;
transmitting a return sweep to the head end tester; and
showing on a display screen the return sweep returned by the head end tester.

6. A test system comprising:
providing a conditioning circuit having a radio frequency input jack and a radio frequency output jack;
cabling a cable modem termination system to the conditioning circuit including coupling the radio frequency input jack and the radio frequency output jack;
signaling an initial ranging request to the cable modem termination system including initializing an interface device; and
determining a transmission power limiter by the conditioning circuit monitoring a network for detecting a cable modem termination system response to the initial ranging request including writing a memory with the transmission power limiter for each of the interface devices.

7. The system as claimed in claim 6 wherein cabling the cable modem termination system includes coupling a downstream cable and an upstream cable to the cable modem termination system including providing a cable modem attach point for coupling the radio frequency input jack and the radio frequency output jack.

8. The system as claimed in claim 6 further comprising analyzing a return path by using the transmission power limiter including transmitting a return sweep through a cable modem attach point, an upstream cable, a test coupling, or a combination thereof.

9. The system as claimed in claim 6 wherein providing the conditioning circuit includes:
controlling a radio frequency receiver by the conditioning circuit for monitoring a downstream communication flow;
controlling a radio frequency transmitter by the conditioning circuit for joining an upstream communication flow; and
controlling the transmission power limiter by the conditioning circuit including adjusting a return sweep with no operator intervention.

10. The system as claimed in claim 6 wherein monitoring the network includes:
attaching a downstream cable to the conditioning circuit including coupling a cable modem attach point, a test coupling, or a combination thereof;
attaching an upstream cable to the conditioning circuit including coupling the cable modem attach point, the test coupling, or the combination thereof;
providing a head end tester coupled between the downstream cable and the upstream cable for analyzing a downstream communication flow, an upstream communication flow, or a combination thereof;
transmitting a return sweep to the head end tester including transmitting through the cable modem attach point, the test coupling, or the combination thereof; and
showing on a display screen the return sweep returned by the head end tester for analyzing a return path.

11. A test system comprising:
a controller unit;
a cable modem termination system connection to the controller unit for sending an initialization request; and
a transmission power limiter determined by the controller unit includes a network connection for receiving a response to the initial ranging request.

12. The system as claimed in claim 11 wherein the cable modem termination system cabled includes a downstream cable and an upstream cable coupled to the cable modem termination system.

13. The system as claimed in claim 11 further comprising a return path coupled to the cable modem termination system includes a cable modem attach point, an upstream cable, a test coupling, or a combination thereof.

14. The system as claimed in claim 11 wherein the controller unit includes:
a conditioning circuit;
a radio frequency receiver controlled by the conditioning circuit;
a radio frequency transmitter controlled by the conditioning circuit; and
the transmission power limiter controlled by the conditioning circuit.

15. The system as claimed in claim 11 wherein the network connection includes:
a downstream cable attached to the controller unit;
an upstream cable attached to the controller unit; and
a head end tester coupled between the downstream cable and the upstream cable for receiving a return sweep.

16. The system as claimed in claim 11 further comprising:
a radio frequency input jack and a radio frequency output jack for connecting the cable modem termination system; and
a memory coupled to the conditioning circuit for storing the transmission power limiter from the cable modem termination system.

17. The system as claimed in claim 16 wherein the cable modem termination system connection includes a downstream cable and an upstream cable coupled to the cable modem termination system includes a cable modem attach point for coupling the radio frequency input jack and the radio frequency output jack.

18. The system as claimed in claim 16 further comprising a return path coupled to the cable modem termination system includes a cable modem attach point, an upstream cable, a test coupling, or a combination thereof between the cable modem termination system and the controller unit.

19. The system as claimed in claim 16 wherein the controller unit includes:
a conditioning circuit;
a radio frequency receiver controlled by the conditioning circuit for monitoring an output of the cable modem termination system;
a radio frequency transmitter controlled by the conditioning circuit for sending an input to the cable modem termination system; and
the transmission power limiter controlled by the conditioning circuit includes a return sweep adjusted with no operator intervention.

20. The system as claimed in claim 16 wherein the network connection includes:
a downstream cable attached to the controller unit includes a cable modem attach point, a test coupling, or a combination thereof;
an upstream cable attached to the controller unit includes the cable modem attach point, the test coupling, or the combination thereof; and
a head end tester coupled between the downstream cable and the upstream cable for receiving a return sweep from the controller unit.
